(19) United States
(12) Patent Application Publication
(10) Pub. No.: US 2014/0373818 A1
(43) Pub. Date: Dec. 25, 2014

(54) AIR SUPPLY SYSTEM

(71) Applicant: HITACHI METALS, LTD., Tokyo (JP)

(72) Inventor: Yoshinori SUNAGA, Hitachinaka (JP)

(21) Appl. No.: 14/302,686

(22) Filed: Jun. 12, 2014

(30) Foreign Application Priority Data
Jun. 25, 2013 (JP) 2013-132477

(51) Int. Cl. F02M 25/07

(52) U.S. Cl. CPC F02M 25/0753
USPC 123/568.11

(57) ABSTRACT

An air supply system includes a displacement type compressor attached to an intake pipe of an engine, a motor that is variable in rotation number and configured to drive the compressor, and an arithmetic circuit configured to control the rotation number of the motor so as to control an amount of air supplied to the engine by the compressor.

The present application is based on Japanese patent application No. 2013-132477 filed on Jun. 25, 2013, the entire contents of which are incorporated herein by reference.

### BACKGROUND OF THE INVENTION

1. Field of the Invention

This invention relates to an air supply system.

2. Description of the Related Art

In recent years, a downsizing to reduce the engine displacement is frequently carried out for improving the fuel consumption. In general, the downsizing is carried out so as to reduce the engine displacement to lower the intake loss and mechanical loss, and simultaneously so as to compensate the reduced amount of torque and output due to the reduction of the displacement by using a supercharging that means supplying the air into an engine by a pressure not less than atmospheric pressure.

In general, the supercharging is carried out by using a turbocharger to rotate a turbine by the exhaust gas of engine so as to operate a compressor, or a supercharger to be driven by the output shaft of engine connected by a dedicated electromagnetic clutch, or both of them.

The related art literature information relating to the invention of the present application may include WO 2005/085611.

### SUMMARY OF THE INVENTION

The turbocharger is configured to rotate a turbine by the exhaust gas of engine and, therefore, it causes a problem in terms of drivability since it takes a long time until sufficient torque is gained after an accelerator is turned on.

In addition, the turbocharger is configured to be driven by the power of exhaust gas and, therefore, it causes a further problem that it is difficult to control the amount of air supply and, eventually, when the supercharging pressure becomes too high (as in the case that the accelerator is suddenly turned off), there is nothing for it but to discard the compressed air through the waste gate, which invites a waste of energy.

On the other hand, the supercharger is suited to promptly gain a high torque, but due to being driven by the output shaft of engine, it causes a problem that the engine output reduces according to the drive of the supercharger and, particularly, when driven at a high revolution, the efficiency deteriorates.

In addition, the supercharger can only conduct ON/OFF control and, therefore, even if only small amount of the pressure of supercharging is needed, the supercharging pressure of 100% must be produced. Thus, the excessive amount of compressed air will be discarded so as to invite a waste of energy.

Furthermore, the supercharger is controlled by the electromagnetic clutch and, therefore, it causes a further problem that due to the complicated control, it is difficult to make smooth the relationship between the accelerator and the output torque. Thus, the fine optimization of the parts is needed so as to have the smooth drive of the supercharger.

It is an object of the invention to provide an air supply system that can offer a good drivability, an efficient operation with reduced energy waste and a simple control.

(1) According to one embodiment of the invention, an air supply system comprises:
a displacement type compressor attached to an intake pipe of an engine;
a motor that is variable in rotation number and configured to drive the compressor; and
an arithmetic circuit configured to control the rotation number of the motor so as to control an amount of air supplied to the engine by the compressor.

In the above embodiment (1) of the invention, the following modifications and changes can be made.

(i) The arithmetic circuit is configured to decide the amount of air supplied to the engine based on at least two parameters of a rotation number of the engine, a flow rate of the air supplied and a pressure in an intake manifold, and an accelerator opening degree, and to control the rotation number of the motor so as to have the decided amount of air supplied.

(ii) The compressor comprises a screw type compressor.

(iii) The air supply system further comprises:

a bypath flow channel configured to connect one site of the intake pipe on an upstream side of the compressor and another site of the intake pipe on an downstream side of the compressor.

(iv) The arithmetic circuit is configured to stop the compressor when the rotation number of the engine corresponds to an idle rotation number.

(v) The air supply system further comprises:

a knock sensor configured to detect knocking of the engine, and

wherein the arithmetic circuit is configured to control the rotation number of the motor based on an output of the knock sensor.

(vi) The system is configured to be mounted in an automobile equipped with a regenerative brake.

### Effects of the Invention

According to one embodiment of the invention, an air supply system can be provided that can offer a good drivability, an efficient operation with reduced energy waste and a simple control.

### BRIEF DESCRIPTION OF THE DRAWINGS

The preferred embodiments according to the invention will be explained below referring to the drawings, wherein:

FIG. 1 is an explanatory view schematically showing an air supply system according to one embodiment of the invention; and

FIG. 2 is an explanatory view schematically showing an air supply module obtained by modularizing the air supply system shown in FIG. 1.

### DETAILED DESCRIPTION OF THE PREFERRED EMBODIMENTS

The embodiment according to the invention will be explained below referring to the attached drawings.

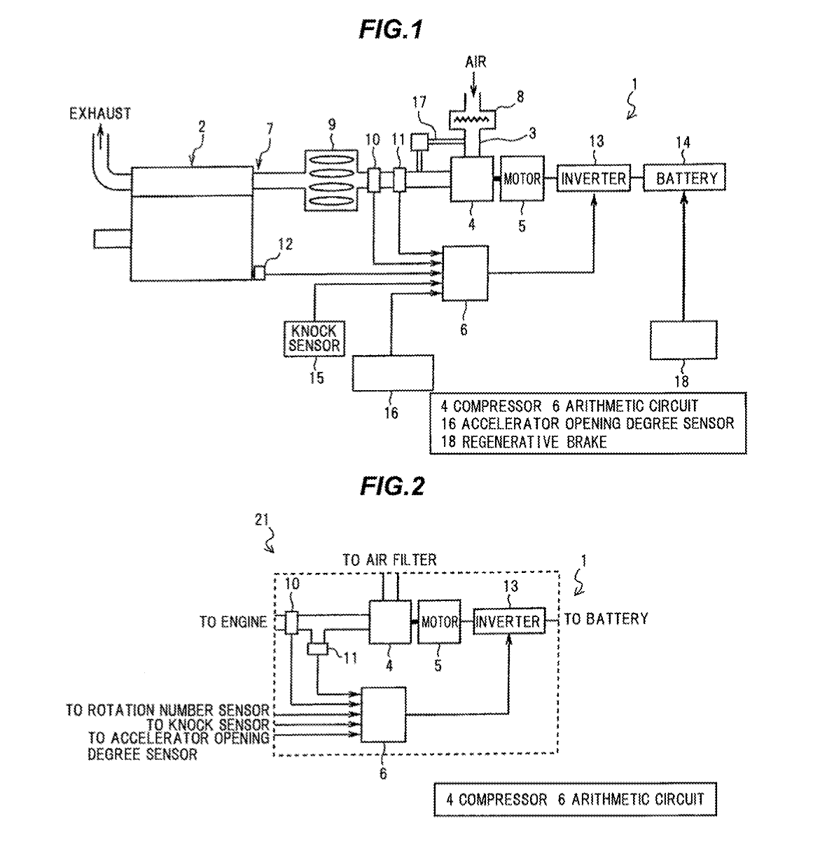

FIG. 1 is an explanatory view schematically showing an air supply system according to one embodiment of the invention.

As shown in FIG. 1, an air supply system 1 includes a compressor 4 of a displacement type disposed in an intake pipe 3 of an engine 2, a motor 5 of which rotation number is variable configured to drive the compressor 4, and an arithmetic circuit (controller) 6 configured to control the rotation number of the motor 5, thereby to control an amount of air supply to the engine 2 by the compressor 4.

The engine 2 is a gasoline engine. In the embodiment, a throttle valve that is generally disposed in the gasoline engine is not used, but an amount of air supply (an amount of supercharging) is adjusted only by the compressor 4 in both of supercharging and non-supercharging.

The intake pipe 3 is configured such that one end thereof is connected to an intake manifold 7 of the engine 2, and another end thereof is released to the atmosphere. In the intake pipe 3 on the upstream side of the compressor 4 (on the opposite side to the engine 2), an air cleaner 8 is disposed, and in the intake pipe 3 on the downstream side of the compressor 4 (on the engine 2 side), an intercooler 9 is disposed.

In addition, in the intake pipe 3 on the downstream side of the compressor 4 and on the upstream side of the intercooler 9, a flow sensor (an air flow sensor) 10 configured to measure a flow amount of air supply and a pressure sensor 12 are disposed. In the engine 2, a rotation number sensor 12 configured to detect the rotation number of engine is disposed.

As the compressor 4, a compressor of a displacement type is used, since it is needed to use a compressor configured to be capable of reducing the flow of air and to have a structure that can prevent the air from flowing in an opposite direction. As the compressor 4, it is preferred to use a compressor configured to have efficiency as high as possible, since the compressor 4 is almost always driven at the time of driving the engine, thus it is preferred to use a compressor of a screw type configured to be capable of operating with high efficiency.

The compressor 4 is joined to the output shaft of the motor 5 so as to be driven.

As the motor 5, a motor configured such that the rotation number is variable is used. In the embodiment, an inverter control motor is used as the motor 5. To the motor 5, an inverter 13 configured to control the drive of motor 5 is connected. To the inverter 13, a battery (a power supply device) 14 is connected.

An arithmetic circuit 6 is a circuit configured to control the rotation number of the motor 5, thereby so as to control the amount of air supply to the engine 2 by the compressor 4. The arithmetic circuit 6 is configured to control the motor 5 to have the desired rotation number via the inverter 13. Further, the motor 5 almost always drives the compressor 4, thus there are concerns about increase in power consumption, but the pressure of the intake manifold 7 is lower than the atmospheric pressure in most of travelling time of motor vehicle and the compressor 4 does not work so that even if the motor 5 is rotated, the motor 5 is in a state that the load thereto is extremely light.

A signal line for input to which output signals from the flow sensor 10, the pressure sensor 11, the rotation number sensor 12, the knock sensor 15 and the accelerator opening degree sensor 16 are input is connected to the arithmetic circuit 6. In addition, a signal line for output configured to be connected to the inverter 13 is connected to the arithmetic circuit 6.

The arithmetic circuit 6 is configured to decide the amount of air supply to the engine 2 based on the engine rotation number of the engine 2 measured by the rotation number sensor 12, the flow amount of air supply measured by the flow sensor 10, the pressure of the intake manifold 7 measured by the pressure sensor 11 and the accelerator opening degree obtained from the accelerator opening degree sensor 16, and to control the rotation number of the motor 5 so as to realize the decided amount of air supply.

Further, the three parameters of the engine rotation number, the flow amount of air supply and the pressure of the intake manifold 7 are not respectively independent, thus, for example, the flow amount of air supply can be calculated from the engine rotation number and the pressure of the intake manifold 7. Consequently, the arithmetic circuit 6 can be also configured to decide the amount of air supply to the engine 2 based on two parameters of the above-mentioned three parameters and the accelerator opening degree.

In addition, in the embodiment, the pressure measured by the pressure sensor 11 disposed in the intake pipe 3 is used as an approximate pressure of the intake manifold 7, but needless to say, it is also possible to dispose the pressure sensor 11 in the intake manifold 7.

A method for deciding the amount of air supply (the rotation number of the motor 5) based on each parameter is not particularly limited, but for example, a configuration can be adopted that a map of the amount of air supply referred by each parameter and a map showing a relationship between the amount of air supply and the rotation number of the motor 5 are preliminarily mounted, and by using these maps and based on each parameter, an appropriate amount of air supply (amount of supercharging) according to the operating state, and the rotation number of the motor 5 appropriate for the amount of air supply (amount of supercharging) are decided.

In the air supply system 1 according to the embodiment, the amount of air supply is adjusted only by the compressor 4, thus it is possible to greatly change characteristics such as drivability, fuel consumption by control contents due to the arithmetic circuit 6. Consequently, the arithmetic circuit 6 can be also configured such that the characteristics (operation modes) can be switched in accordance with preference of user by mounting a map having a plurality of patterns, for example, the operation modes including a mode by which sensitive response can be obtained for an accelerator operation and a mode that reduces fuel consumption by slowing down acceleration.

In addition, the air supply system 1 further includes a bypath flow channel 17 configured to connect the intake pipe 3 on an upstream side of the compressor 4 and the intake pipe 3 on an downstream side of the compressor 4 so as to guide an air to bypass the compressor 4, and the air supply system 1 is configured such that when being in an idling state, the air supply is carried out by using the bypath flow channel 17 without using the compressor 4. In the bypath flow channel 17, a check valve (not shown) configured to prevent an air from flowing in an opposite direction is disposed.

The arithmetic circuit 6 is configured to stop the compressor 4 and the motor 5 when the engine rotation number of the engine 2 is an idle rotation number. Thereby, when being in an idling state, the compressor 4 and the motor 5 are stopped so that power consumption can be prevented.

Further, if the supercharging pressure becomes excessively high, abnormal combustion occurs in the cylinder of the engine 2 so as to cause knocking, thus the arithmetic circuit 6 can be also configured to control the amount of air supply to be reduced until the knocking is suppressed when the occurrence of the knocking in the engine 2 is detected by the knock sensor 15.

In addition, conversely, the supercharging pressure may be raised until the knocking occurs, thus at the time of supercharging, the arithmetic circuit 6 can be also configured to control the supercharging pressure to raise until the occurrence of the knocking in the engine 2 has been detected by the knock sensor 15.

Furthermore, the air supply system 1 is configured to be mounted in the motor vehicle equipped with the regeneration brake 18 configured to recover kinetic energy of the motor vehicle as electric power at the time of braking so that the motor 5 is driven by electric power obtained by the regeneration brake 18. If electric power is generated by the regeneration brake 18, and the motor 5 is driven by electric power charged in the battery 14 so that the compressor 4 is driven, this results in changing the energy recovered by the regeneration brake 18 to a driving force of the motor vehicle, thus as a result, the same operation as a hybrid motor vehicle can be obtained.

As shown in FIG. 2, the air supply system 1 can be also modularized. Further, in the air supply module 21 shown in FIG. 2, the bypath flow channel 17 is omitted.

Just by mounting the air supply module 21 of FIG. 2 (air supply system 1) in a motor vehicle equipped with a usual gasoline engine, as a result, a motor vehicle that is capable of saving fuel consumption and realizing strong and smooth operation can be obtained.

Further, only by mounting the air supply module 21 in a motor vehicle equipped with a usual gasoline engine, a compression ratio becomes excessively high at the time of supercharging so as to cause the knocking, thus as being generally and commonly carried out in the case of mounting a supercharger such as a turbocharger, it is preferred to realize an Atkinson cycle (a Mirror cycle) operation by a method such as direct fuel injection into the cylinder, delay of the timing of closing the intake valve of the engine 2.

The Atkinson cycle engine is an engine configured to increase an expansion ratio than a compression ratio so as to use up the energy of combustion gas for a force pressing a piston as much as possible, thus combustion efficiency is enhanced and an exhaust temperature is lowered. However, in a state of being without supercharging, output torque is reduced relative to the same displacement, and an exhaust temperature is lowered, thus it is incompatible with the turbocharger. This is due to the fact that the defect of the turbocharger of being hard to obtain low-speed torque is further worsened.

The turbocharger is configured to recover an energy disposed as an exhaust gas so as to reuse, on the other hand, the Atkinson cycle engine is configured to recover an energy to be disposed by shaft output of piston. Consequently, the Atkinson cycle engine having good efficiency can be practically used for a downsizing power train only through use of a supercharger. However, in a usual supercharger configured to be driven by engine shaft output, the shaft output is consumed, thus the output power is reduced.

The air supply system 1 according to the embodiment is configured to electrically drive the compressor 4 by the motor 5 without using an engine shaft output, thus an engine output is increased for that portion, so that it can be used for a force propelling a motor vehicle. If a configuration that electric power for driving the compressor 4 is provided by electric power obtained by the regeneration brake 18 is adopted, it becomes possible to realize a motor vehicle having better energy efficiency (namely good fuel consumption).

As explained above, the air supply system 1 according to the embodiment includes the compressor 4 of a displacement type disposed in the intake pipe 3 of the engine 2, the motor 5 of which rotation number is variable configured to drive the compressor 4, and the arithmetic circuit 6 configured to control the rotation number of the motor 5, thereby to control an amount of air supply to the engine 2 by the compressor 4.

The air supply system 1 is configured to drive the compressor 4 by the motor 5, thus it is capable of supplying an appropriate supply air to the engine 2 without delay for an accelerator operation, and realizing good drivability.

The air supply system 1 is configured to control the air supply to the engine 2 only by the compressor 4, consequently an act of disposing a compressed air as in a conventional case where an adjustment of the supercharging and the amount of air supply is carried out by a different device (a turbocharger or a supercharger and a throttle valve) is prevented, thus this makes it possible to achieve an operation having good efficiency and slight waste of energy.

In addition, the air supply system 1 does not need a complex control such as a clutch control, thus it can be realized by a simple control configured to decide the amount of air supply (the rotation number of the motor 5) according to each parameter.

Furthermore, the air supply system 1 does not use a throttle valve, thus cost reduction can be achieved for that portion.

The air supply system 1 is configured to carry out both of the usual air supply and the supercharging by the compressor 4, thus this makes it possible to remove the border between the supercharging state (the intake manifold is not less than the atmospheric pressure) and the non-supercharging state so as to realize an extremely smooth engine control.

Further, the arithmetic circuit 6 is configured not to increase the air supply pressure in case of the non-supercharging state (not to make the compressor 4 perform work of compression) so as to carry out a minimum required compression, thereby power consumption (electric power loss, power loss) of the motor 5 for driving the compressor 4 can be depressed to a small value.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

For example, although not mentioned in the above-mentioned embodiment, the air supply system 1 of the invention can be also used in combination with the turbocharger or the supercharger. For example, for the purpose of suppressing power consumption in the motor 5 at high speed travelling, it is considered that the turbocharger is simultaneously used or the like. However, in this case, it is necessary that a flow amount adjustment means is separately disposed for controlling the amount of air supply (amount of supercharging) instead of throttle valve.

What is claimed is:

1. An air supply system, comprising:
a displacement type compressor attached to an intake pipe of an engine;
a motor that is variable in rotation number and configured to drive the compressor; and
an arithmetic circuit configured to control the rotation number of the motor so as to control an amount of air supplied to the engine by the compressor.

2. The air supply system according to claim 1, wherein the arithmetic circuit is configured to decide the amount of air supplied to the engine based on at least two parameters of a rotation number of the engine, a flow rate of the air supplied and a pressure in an intake manifold, and an accelerator opening degree, and to control the rotation number of the motor so as to have the decided amount of air supplied.

3. The air supply system according to claim 1, wherein the compressor comprises a screw type compressor.

4. The air supply system according to claim 1, further comprising:
a bypath flow channel configured to connect one site of the intake pipe on an upstream side of the compressor and another site of the intake pipe on an downstream side of the compressor.

5. The air supply system according to claim 4, wherein the arithmetic circuit is configured to stop the compressor when the rotation number of the engine corresponds to an idle rotation number.

6. The air supply system according to claim 1, further comprising:
a knock sensor configured to detect knocking of the engine, and
wherein the arithmetic circuit is configured to control the rotation number of the motor based on an output of the knock sensor.

7. The air supply system according to claim 1, wherein the system is configured to be mounted in an automobile equipped with a regenerative brake.
